(19) United States
(12) Patent Application Publication
(10) Pub. No.: US 2024/0360705 A1
(43) Pub. Date: Oct. 31, 2024

(54) ASSEMBLY FOR OPENING AND/OR CLOSING A VEHICLE DOOR

(71) Applicant: MINEBEA ACCESSSOLUTIONS ITALIA S.P.A., Pianezza (IT)

(72) Inventors: Marco SAVANT, PIANEZZA (IT); Anthony GUERIN, PIANEZZA (IT)

(73) Assignee: MINEBEA ACCESSSOLUTIONS ITALIA S.P.A., Pianezza (IT)

(21) Appl. No.: 18/769,589

(22) Filed: Jul. 11, 2024

Related U.S. Application Data
(63) Continuation of application No. PCT/EP2023/050491, filed on Jan. 10, 2023.

(30) Foreign Application Priority Data
Jan. 11, 2022 (EP) 22150930.0

(51) Int. Cl. E05B 81/78; E05B 81/76

(52) U.S. Cl. CPC E05B 81/78; E05B 81/77

(57) ABSTRACT

An assembly includes a handle comprising a cover member and at least one sensor. The cover member includes a frame part and an inner wall part allowing an access by the user's hand to at least one electronic switch of a bracket. The at least one sensor is configured to detected a user's hand so as to allow a locking and/or an unlocking of the door when the user's hand is detected, positioned such that, when the user's hand is inserted in the cover member in order to reach the at least one electronic switch, the user's hand is detected by the at least one sensor before the user's hand reaches the at least one electronic switch.

### CROSS-REFERENCE TO RELATED APPLICATIONS

This application is a continuation of International Application No. PCT/EP2023/050491, filed on Jan. 10, 2023, which claims priority to and the benefit of EP application Ser. No. 22/150,930.0 filed on Jan. 11, 2022. The disclosures of the above applications are incorporated herein by reference.

### FIELD

The present invention relates to an assembly for opening and/or closing a vehicle door, in particular to an electronic assembly for opening and/or closing the vehicle door.

### BACKGROUND

The statements in this section merely provide background information related to the present disclosure and may not constitute prior art.

Electronic assemblies for opening and/or closing a vehicle door generally comprise a handle, a bracket to which the handle is secured and electronic means configured to unlock the vehicle door and to activate a latch, such as an electronic latch, to open the vehicle door.

Because the electronic means generally implement the unlocking function and opening function at the same time, a wall effect, which means that the door opens at once, but a certain time after the input of the user due to the time necessary to unlock before opening, may happen. This wall effect is however undesirable

### SUMMARY

This section provides a general summary of the disclosure and is not a comprehensive disclosure of its full scope or all of its features.

An object of the invention is to overcome this problem and concerns to this end an assembly for opening and/or closing a vehicle door, the assembly comprising a handle comprising a cover member configured to be secured to a bracket, the bracket comprising at least one electronic switch configured to be activated by a user's touch so as to send a signal to an electronic latch to open the door. The cover member includes a frame part, an inner wall part extending from the frame part so as to allow an access by the user's hand to the at least one electronic switch of the bracket. The assembly further comprises at least one sensor configured to detect a user's hand so as to allow a locking and/or an unlocking of the vehicle door when the user's hand is detected, the at least one sensor being positioned such that, when the user's hand is inserted in the cover member in order to reach the at least one electronic switch, the user's hand is detected by the sensor before the user's hand reach the at least one electronic switch so as to allow the unlocking of the vehicle door.

The location of the detection range of the at least one sensor permits to anticipate by a few seconds the unlocking of the vehicle door before the electronic switch is reached by the user's hand to open the vehicle door. This permits to avoid wall effect.

According to further embodiments which can be considered alone or in combination.

The at least one sensor has an unlocking sensing range extending between the frame part and the at least one electronic switch.

The at least one sensor has a locking sensing range extending upstream the unlocking sensing range along the course followed by the user's hand so at to reach the at least one electronic switch.

The at least one sensor is arranged on a side of the cover member, opposite to a side of the cover member intended to face the user's hand when the user's hand is inserted in the cover member in order to reach the at least one electronic switch.

The at least one sensor is arranged against the inner wall part of the cover member.

The at least one sensor is a capacitive sensor.

The at least one sensor includes a locking detection part configured to detect the user's hand so as to allow the locking of the door and an unlocking detection part configured to detected the user's hand so as to allow the unlocking of the door.

The locking detection part extends by a non-zero angle from the unlocking detection area.

The at least one sensor is a standalone sensor.

The assembly can further comprise the bracket, the bracket being configured to be assembled to the inner side of the door, the bracket comprising the at least one electronic switch configured to be activated by a user's touch so as to send the signal to the electronic latch to open the door.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an assembly for opening and/or closing a vehicle door according to an example of embodiment of the invention.

FIG. 2 shows a handle and a bracket of the assembly of FIG. 1 before mounting on a vehicle door.

FIG. 3 shows a cross-sectional view of the assembly of FIG. 1 mounted on the vehicle door.

FIG. 4 shows the bracket of the assembly of FIG. 1 assembled to the vehicle door.

FIG. 5 shows the bracket of the assembly of FIG. 1.

FIG. 6 is a rear view of the assembly of FIG. 1.

FIG. 7 shows a cover member of the assembly of FIG. 1.

FIG. 8 shows a sensor secured to the cover member of the assembly of FIG. 1.

FIG. 9 shows ranges of the assembly of FIG. 1.

FIG. 10 shows the sensor of the assembly of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

### Assembly

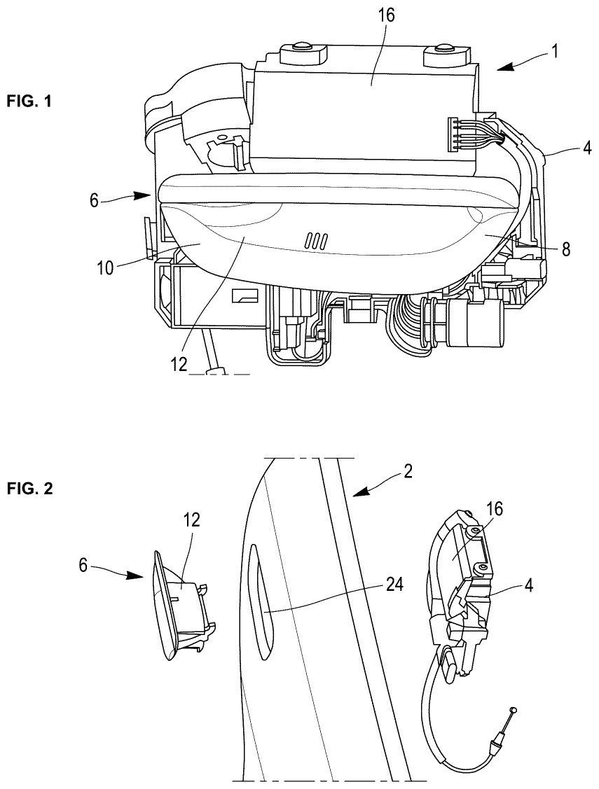

FIG. 1 illustrates an assembly 1 for opening and/or closing a vehicle door 2 (FIG. 2).

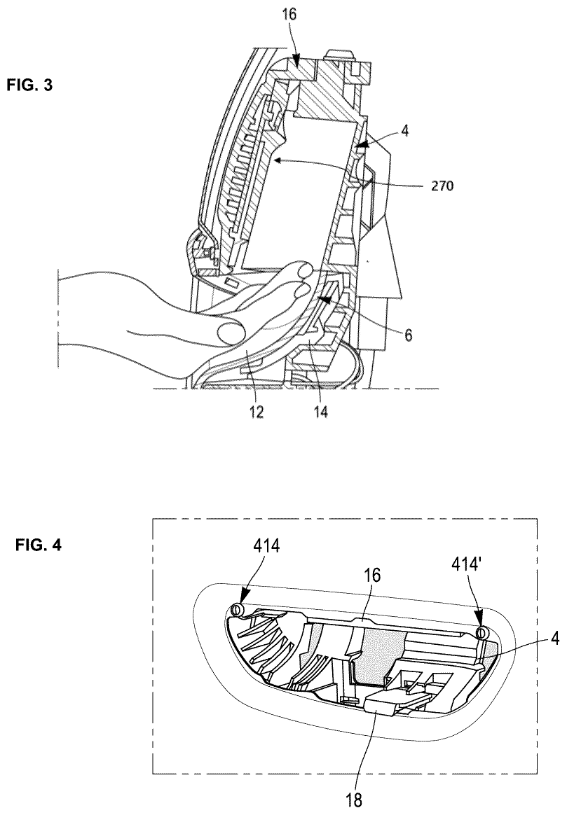

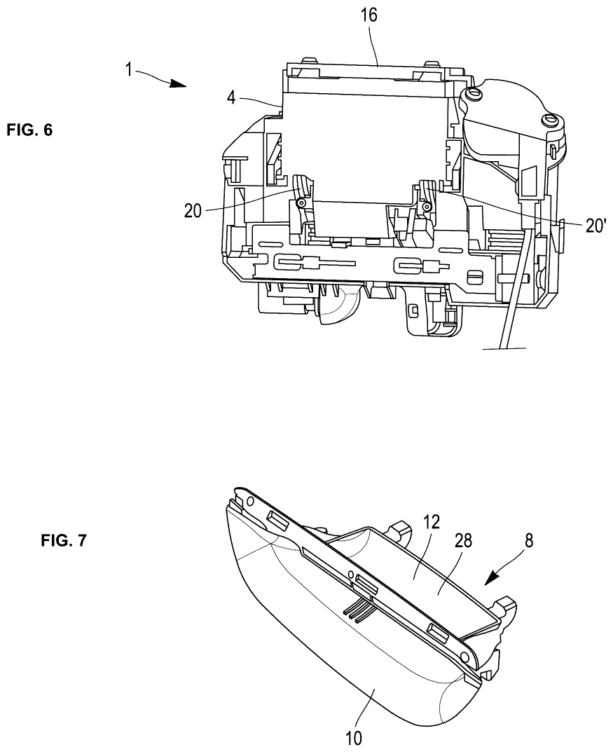

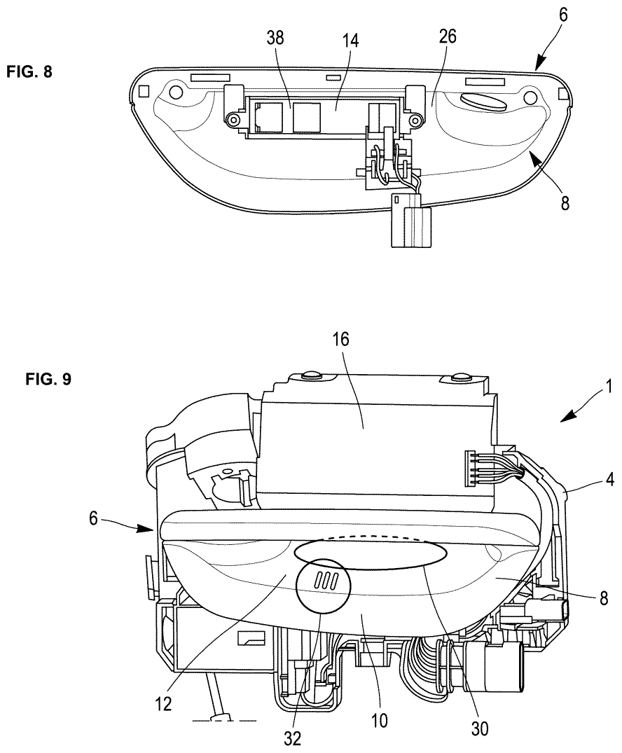

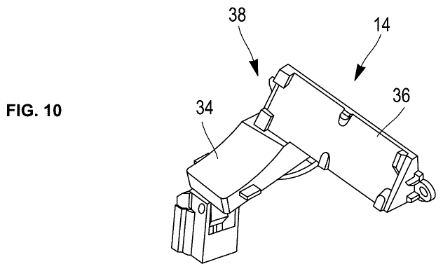

The assembly 1 comprises a handle 6 comprising a cover member 8. The cover member can be configured to be secured to a bracket 4 (FIG. 6). Such a bracket can comprise at least one electronic switch configured to be activated by a user's touch so as to send a signal to an electronic latch to open the door 2. The cover member 8 comprises a frame part 10, and an inner wall part 12 extending from the frame 10 so as to allow an access by the user's hand to the at least one electronic switch of the bracket 4. The assembly 1 comprises at least one sensor 14 (FIGS. 8 and 10) configured to detect a user's hand so as to allow a locking and/or an unlocking of the door when the user's hand is detected, the at least one sensor 14 being positioned such that, when the user's hand is inserted in the cover member, for example in order to reach at least one electronic switch, for example such at least one electronic switch, the user's hand is detected by the sensor before the user's hand reach the at least one electronic switch so as to allow the unlocking of the door (FIG. 3).

The location of the detection range of the at least one sensor permits to anticipate by a few seconds the unlocking of the vehicle door before the electronic switch is reached by the user's hand to open the vehicle door. This permits to avoid wall effect.

### Bracket

The assembly 1 can further comprise the bracket 4 configured to be assembled to an inner side of the door 2 (FIG. 2). The bracket 4 comprises the at least one electronic switch configured to be activated by a user's touch so as to send a signal to an electronic latch (not shown) to open the vehicle door 2.

The bracket 4 is configured to be assembled to the inner side of the door (FIG. 2).

By “assembled to the inner side”, it is to be understood that the bracket can be fixed or attached or assembled by any suitable means to the inner side of the door.

By “inner side of the door”, it is understood for example the side of the door destined to face the vehicle interior, by opposition to an outer side of the door destined to be disposed towards the exterior environment.

For example, the bracket 4 is assembled to the inner side of the door 2. For example, the cover member 8 is secured to the bracket 4.

For example, as illustrated in FIG. 4, the bracket 4 is fixed to the inner side of the door by means of screws 414, 414′. For example, the bracket is fixed to the inner side of the door by means a first screw 414 and second screw 414′.

As illustrated in FIG. 4, the bracket 4 is positioned against the inner side of the vehicle door 2.

The bracket 4 comprises at least one electronic switch configured to be activated by a user's touch, for example, by mean of a user's finger touch.

When activated by the user's touch, the electronic switch sends a signal to an electronic latch (not shown) so that the electronic latch opens the vehicle door 2.

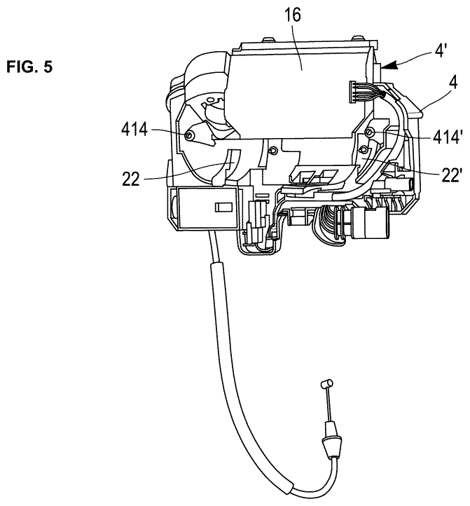

As illustrated in FIG. 5, the at least one switch is arranged on an upper part 4′ of the bracket 4.

The at least one switch is arranged behind a casing 16 arranged on the upper part of the bracket 4.

### Cover Member

The cover member 8 of the handle is configured be secured to the bracket 4.

To this end, the bracket 4 and the cover member 8 comprises complementary fastening means which cooperate with each other so that the cover member can be secured to the bracket 4.

For example, the bracket 4 comprises clipping means 18 (FIG. 4) and the cover member 8 comprises at least one housing (not visible) configured to receive the clipping means 18 of the bracket 4. The bracket 4 can comprise at least one aperture, the assembly being configured such that the clipping means 18 can be inserted through at least one aperture of the bracket 4, for example so as to reach the at least one housing.

As illustrated in FIG. 6, the cover member 8 comprises two clipping means 20, 20′ and the bracket 4 comprises two corresponding housings 22, 22′ (FIG. 5) each configured to receive one of the clipping means 20, 20′ of the cover member 8.

For instance, the assembly is configured such that the cover member can be locked in position to the bracket 4. To this extent, the bracket 4 can comprise a locking element. The locking element can be configured such that a sliding of the locking element with respect to a body of the bracket 4 allows for locking the cover member 8 on the bracket 4. The locking can result from the locking element being positioned at least partially between the clipped clipping means and the aperture.

As illustrated in FIG. 1, the cover member 8 is configured to be assembled to the external side of the vehicle door 2, opposite to the inner side of the door 2.

To this end, the vehicle door 2 comprises an opening 24 (FIG. 2) so that the cover member 8 can be assembled to the external side of the door 2 and secured to the bracket 4.

As illustrated in FIG. 7, the frame part 10 of the cover member 8 is sized so that a user's hand can passes through the frame 10 (FIG. 3).

The frame part 10 is configured to be positioned against the external side of the vehicle door.

The inner wall part 12 of the cover member 8 extends from the frame part 10. The inner wall part 12 extends from the frame part 10 so as to allow access by the user's hand the at least one electronic switch 270 of the bracket 4 when the handle is secured to the bracket 4 (FIG. 3). The inner wall part can form a guide to the at least one electronic switch.

To this end, the inner wall part 12 can be tilted with respect to the frame part 8. This configuration permits to guide the user's hand toward the at least one electronic switch arranged on the upper part of the bracket 4 (FIG. 3).

By “upper”, respectively “lower”, it is for example understood with respect to a vertical axis, for example the axis orthogonal to the ground when the vehicle is on a flat ground.

For example, the inner wall part is curved (FIG. 7).

The frame part 10 and the tilted inner wall part may form a bowl shape element. For instance, the frame part 10 and the tilted inner wall part may form a handle of the bowl type, for instance a bowl-shaped handle.

The frame part 10 and the inner wall part 12 can be made integrally.

Optionally, the vehicle door can be manually and mechanically opened, by means of the mechanical lockset.

To this end, the handle 6 comprises a gripping means configured to be graspable by the user's hand to manually open the vehicle door.

For example, the gripping means is arranged on the frame part 10 of the cover member 8.

For example, the gripping means is a strip such as a chrome strip.

The cover member 8 can comprise at least a main element and a handle element. The main element and the handle element can be attached to each other. For instance, the handle element can form the upper portion of the frame part 10 and the main part can form the remaining portion of the frame part, for instance the side parts and the lower part, and the inner wall part. The handle element can be made integrally. The frame part can be made integrally.

### Sensor

The assembly 1 comprises the at least sensor 14 (FIGS. 8 and 9) configured to detect a user's hand so as to allow a locking and/or an unlocking of the door when the user's hand is detected. The assembly 1 can comprise one or several such sensor(s) 14.

The sensor 14 is positioned such that, when the user's hand is inserted in the cover member 8 in order to reach the at least one electronic switch, the user's hand is detected by the sensor 14 before the user's hand reach the at least one electronic switch so as to allow the unlocking of the door 2 (FIG. 3).

As illustrated in FIG. 3, the arrangement of the sensor 14 permits to anticipate by a few second the unlocking of the vehicle door 2 before the user's hand reach the electronic switch to open the vehicle door 2.

For example, once the user's hand is detected by the sensor 14 to unlock the vehicle door, an unlocking process of the vehicle starts.

The unlocking process comprises a step wherein the vehicle detects if the key of the vehicle (arranged in a pocket of the user for example) is near the vehicle to validate the unlocking of the vehicle door 2, for instance in a certain proximity, for instance at a certain distance of the vehicle.

The detection of the key permits to validate the unlocking of the vehicle door 2. The detection of the key can be done by means of antennas of the vehicle for example. The vehicle door 2 is then unlocked.

Thus, when the user's hand reaches the switch of the bracket 4 so as to send a signal to an electronic latch to open the door 2, the vehicle door 2 is already unlocked.

This permits to avoid wall effect, that is to say that opening of the vehicle door 2 happens with a certain delay after the input of the user as the same input commands for unlocking and opening, which have to be performed one after the other.

As illustrated in FIG. 8, the sensor 14 is arranged on a side 26 of the cover member 8, opposite to a side 28 of the cover member 8 intended to face the user's hand when the user's hand is inserted in the cover member in order to reach the at least one electronic switch.

For example, the sensor 14 is arranged against the inner wall part 12 of the cover member.

For example, the sensor 14 is a capacitive sensor.

As illustrated in FIG. 9, the sensor 14 has an unlocking sensing range 30 extending at least between the frame part 10 and the at least one electronic switch, for instance between the frame part 10 and the at least one electronic switch.

For example, the unlocking sensing range 30 extends substantially over a large area between the frame part 10 and the at least one electronic switch so that the user's hand can be detected regardless of the position of the user's hand when the user's hand accesses the cover member 8. For example, the unlocking sensing range 30 extends substantially over the width of the path defined by the inner wall part 12.

The sensor 14 has a locking sensing range 32 extending upstream the unlocking sensing range 30 along the course followed by the user's hand so as to reach the at least one electronic switch.

Upstream, respectively downstream, means for example with respect to a sense going from the outside of the handle towards the electronic switch, for instance with respect to the sense going from the frame part to the electronic switch, for instance with respect to the movement of the user's hand reaching for the electronic switch.

The locking sensing range 32 extends between the frame part 10 and the unlocking sensing range 30.

The locking sensing range 32 extends substantially over an area smaller than the unlocking sensing range 30. The locking sensing range 32 extends at a central part of the inner wall part 12.

For example, the unlocking sensing range 30 extends over an area equal to at least twice the area of the locking sensing range 32. For instance, the unlocking sensing range 30 extends over an area with a biggest dimension comprised between 15 and 45 mm, for instance between 25 and 35 mm, for example 30 mm. For instance, the area of the locking sensing range extends over an area with a biggest dimension comprised between 2 and 8 mm, for instance between 3 and 6 mm, for example 4 mm. For instance, the unlocking sensing range 30 extends over a distance from the corresponding sensor part comprised between 15 and 45 mm, for instance between 25 and 35 mm, for example 30 mm. For instance, the area of the locking sensing range extends over a distance from the corresponding sensor part comprised between 2 and 8 mm, for instance between 3 and 6 mm, for example 4 mm.

The locking sensing range 32 is arranged so that once the vehicle door 2 has been closed, the locking sensing range 32 is quickly accessible by the user's hand so as to lock the vehicle door 2.

As illustrated in FIG. 10, the sensor 14 comprises a locking detection part 34 configured to detect the user's hand so as to allow the locking of the door and an unlocking detection part 36 configured to detect the user's hand so as to allow the unlocking of the door.

The locking detection part 34 extends by a non-zero angle from the unlocking detection part 36. The angle is for example configured to follow the curve of the inner wall part 12.

For example, the unlocking detection part 36 extends over an area bigger than the area of the locking detection part 34. For example, the unlocking detection part 36 extends over an area equal to at least twice the area of the locking detection part 34.

The sensor 14 is a standalone sensor, that is to say that the sensor 14 is independent from the cover member 8, for instance forms a different element from the cover member 8, for instance only mechanically attached to the cover member 8. For example, the sensor is arranged in a casing 38 fixed to the cover member.

### System

A system can comprise such an assembly and the corresponding vehicle door 2. The assembly is assembled to the vehicle door 2. The assembly can further comprise the vehicle including the vehicle door mounted thereon.

### Method

A method for opening a vehicle door by means of the assembly as previously described comprises a step of detection of a user's hand by means the at least one sensor 14 so as to allow an unlocking of the vehicle door 2.

The method for opening a vehicle door 2 comprises a step of activation of the at least one electronic switch by a user's touch so as to send a signal to an electronic latch to open the door 2.

The step of detection of the user's hand is implemented before the step of activation of the at least one electronic switch.

A method for closing a vehicle door by means of the assembly as previously described comprises the step of—detection of a user's hand by means the at least one sensor 14 so as to allow a locking of the vehicle door 2.

The method of closing can comprise a step of closing of the vehicle door. The closing of the vehicle door 2 is implemented before the step of detection of a user's hand by means the at least one sensor 14 so as to allow a locking of the vehicle door 2.

For example, the closing of the vehicle door 2 is done manually by the user.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An assembly for opening and/or closing a vehicle door, the assembly comprising a handle comprising a cover member configured to be secured to a bracket, the bracket comprising at least one electronic switch configured to be activated by a user's touch so as to send a signal to an electronic latch to open the door,
the cover member comprising:
a frame part,
an inner wall part extending from the frame part so as to allow an access by a user's hand to the at least one electronic switch of the bracket,
wherein the assembly further comprises at least one sensor configured to detect the user's hand so as to allow a locking and/or an unlocking of the door when the user's hand is detected, the at least one sensor being positioned such that, when the user's hand is inserted in the cover member in order to reach the at least one electronic switch, the user's hand is detected by the at least one sensor before the user's hand reach the at least one electronic switch so as to allow the unlocking of the door.

2. The assembly according to claim 1, wherein the at least one sensor has an unlocking sensing range extending between the frame part and the at least one electronic switch.

3. The assembly according to claim 2, wherein the at least one sensor has a locking sensing range extending upstream the unlocking sensing range along a course followed by the user's hand so as to reach the at least one electronic switch.

4. The assembly according to claim 1, wherein the at least one sensor comprises a locking detection part configured to detect the user's hand so as to allow the locking of the door and an unlocking detection part configured to detected the user's hand so as to allow the unlocking of the door.

5. The assembly according to claim 1, wherein the locking detection part extends by a non-zero angle from the unlocking detection part.

6. The assembly according to claim 1, wherein the at least one sensor is arranged on a side of the cover member, opposite to a side of the cover member intended to face the user's hand when the user's hand is inserted in the cover member in order to reach the at least one electronic switch.

7. The assembly according to claim 1, wherein the at least one sensor is arranged against the inner wall part of the cover member.

8. The assembly according to claim 1, wherein the at least one sensor is a capacitive sensor.

9. The assembly according to claim 1, wherein the at least one sensor is a standalone sensor.

10. The assembly according to claim 1, further comprising the bracket, the bracket being configured to be assembled to an inner side of the door, the bracket comprising the at least one electronic switch configured to be activated by the user's touch so as to send the signal to the electronic latch to open the door.
